(19) United States
(12) Patent Application Publication
(10) Pub. No.: US 2026/0104583 A1
(43) Pub. Date: Apr. 16, 2026

(54) MEMS DEVICES FOR EYE TRACKING AND RELATED METHODS

(71) Applicant: Meta Platforms Technologies, LLC, Menlo Park, CA (US)

(72) Inventors: Youmin Wang, Bellevue, WA (US); Francesco La Rocca, Kirkland, WA (US)

(21) Appl. No.: 19/355,148

(22) Filed: Oct. 10, 2025

Related U.S. Application Data
(60) Provisional application No. 63/706,495, filed on Oct. 11, 2024.

(51) Int. Cl. G02B 26/08; G02B 26/10; G02B 27/00; G02B 27/28

(52) U.S. Cl. CPC G02B 26/0833; G02B 26/105; G02B 27/0093; G02B 27/283

(57) ABSTRACT

The disclosed apparatus may include a micro-electromechanical systems (MEMS) mirror configured to oscillate at a first resonant frequency about a first axis and at a second resonant frequency about a second axis. The disclosed apparatus may also include a laser light source configured to direct light to the MEMS mirror to reflect from the MEMS mirror toward a user’s eye for illumination of the user’s eye. Additionally, the MEMS mirror may be configured to illuminate the user’s eye in a scanning pattern that can repeat at a rate, and the repetition rate of the scanning pattern may be tunable by altering a ratio of the first resonant frequency and the second resonant frequency within a range of 1.0:1.8 to 1.0:2.2. Various other methods, systems, and computer-readable media are also disclosed.

### CROSS REFERENCE TO RELATED APPLICATION

This application claims the benefit of U.S. Provisional Application No. 63/706,495, filed October 11, 2024, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for operating a MEMS device for eye tracking.

FIG. 2 is a graphical illustration of exemplary results obtained by tuning a repetition rate of a MEMS mirror of a MEMS device for eye tracking.

FIG. 3 is a graphical illustration of a MEMS mirror of an exemplary MEMS device for eye tracking.

FIG. 4 is a block diagram illustrating an exemplary integrated MEMS module that includes a light detector.

FIG. 5 is a block diagram illustrating an exemplary illumination only integrated MEMS module.

FIG. 6 is a view of an exemplary MEMS scanning eye tracking eyepiece having MEMS devices integrated therein.

FIG. 7 is an illustration of an example augmented-reality system according to some embodiments of this disclosure.

FIG. 8A is an illustration of an example virtual-reality system according to some embodiments of this disclosure.

FIG. 8B is an illustration of another perspective of the virtual-reality systems shown in FIG. 8A.

FIG. 9 is a block diagram showing system components of example augmented- and virtual-reality systems.

FIG. 10 is an illustration of an example system that incorporates an eye-tracking subsystem capable of tracking a user’s eye(s).

FIG. 11 is a more detailed illustration of various aspects of the eye-tracking subsystem illustrated in FIG. 10.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Current eye tracking systems can be categorized into two main types: scanning-based and camera-based. Camera-based eye tracking systems in augmented reality/virtual reality (AR/VR) glasses form factors face challenges in achieving high frame rates exceeding 100 frames per second (fps) while maintaining low power consumption. Additionally, camera systems require multiple LEDs for uniform illumination, which increases power consumption.

In contrast, micro-electromechanical systems (MEMS) scanning techniques can utilize a single light source and bi-resonant scanning to reduce power consumption while maintaining low-cost fabrication processes. However, to achieve parity with camera-based eye tracking performance, several innovations on the MEMS device and scanning module are needed to match high imaging speed, field of view, resolution, and signal-to-noise ratio.

The present disclosure is generally directed to MEMS devices for eye tracking and related methods. As will be explained in greater detail below, embodiments of the present disclosure may oscillate a MEMS mirror at a first resonant frequency about a first axis and at a second resonant frequency about a second axis. Light may be directed from a laser light source to the MEMS mirror to reflect from the MEMS mirror toward a user’s eye for illumination of the user’s eye. A rate of a scanning pattern of the MEMS mirror may be tuned (e.g., dynamically) by altering a ratio of a first resonant frequency and a second resonant frequency within a range of 1.0:1.8 to 1.0:2.2. In this way, the MEMS mirror is configured to illuminate the user’s eye in a scanning pattern that repeats at the rate. Moreover, different frequency pairs used for the tuning may achieve dynamic change in the imaging frame rate and resolution, thus leveraging the frequency tunability of the MEMS mirror in its two resonant axes.

Benefits achieved by the disclosed systems and methods relate to improvements in achieving an AR/VR form factor MEMS scanning eye tracker, targeting for high speed, and a small form-factor eye tracking (ET) system. For example, the disclosed systems and methods achieve imaging speed and resolution requirements of the eye tracking application. The disclosed systems and methods achieve this capability using a high-speed MEMS in combination with a smaller form factor integration module. Additionally, the use of different frequency pairs allows dynamic change in the imaging frame rate and resolution, leveraging the frequency tunability of the MEMS mirror in its two resonant axes. Also, the high resonant frequency may be achieved through large actuation force and high stress mitigation designs of the MEMS mirror. Moreover, integrated MEMS illumination and sensing may leverage the heterogeneous integration of MEMS and laser (e.g., vertical-cavity surface-emitting laser (VCSEL) and detector (e.g., avalanche photodiodes (APD))) on the surface on the MEMS die. In this context, the MEMS may function in the module both as the scanner and the sub-mount for both the laser and the detector. Necessary routing for electrical connection and data readout may be achieved through additional routing on the MEMS device. Further, a tilted window may be specially designed to guarantee both large FOV without occlusion and less back reflection into the inner cavity of the module.

Features from any of the embodiments described herein may be used in combination with one another in accordance with the general principles described herein. These and other embodiments, features, and advantages will be more fully understood upon reading the following detailed description in conjunction with the accompanying drawings and claims.

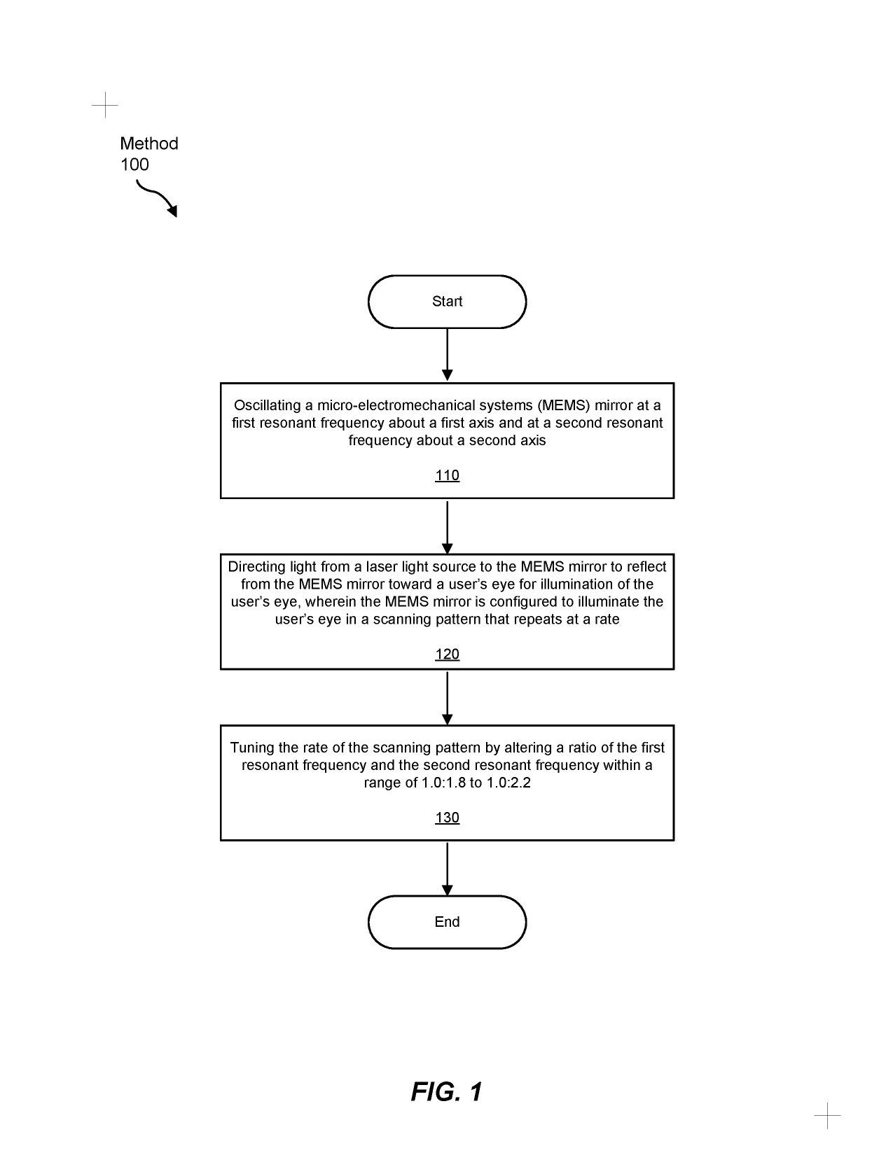

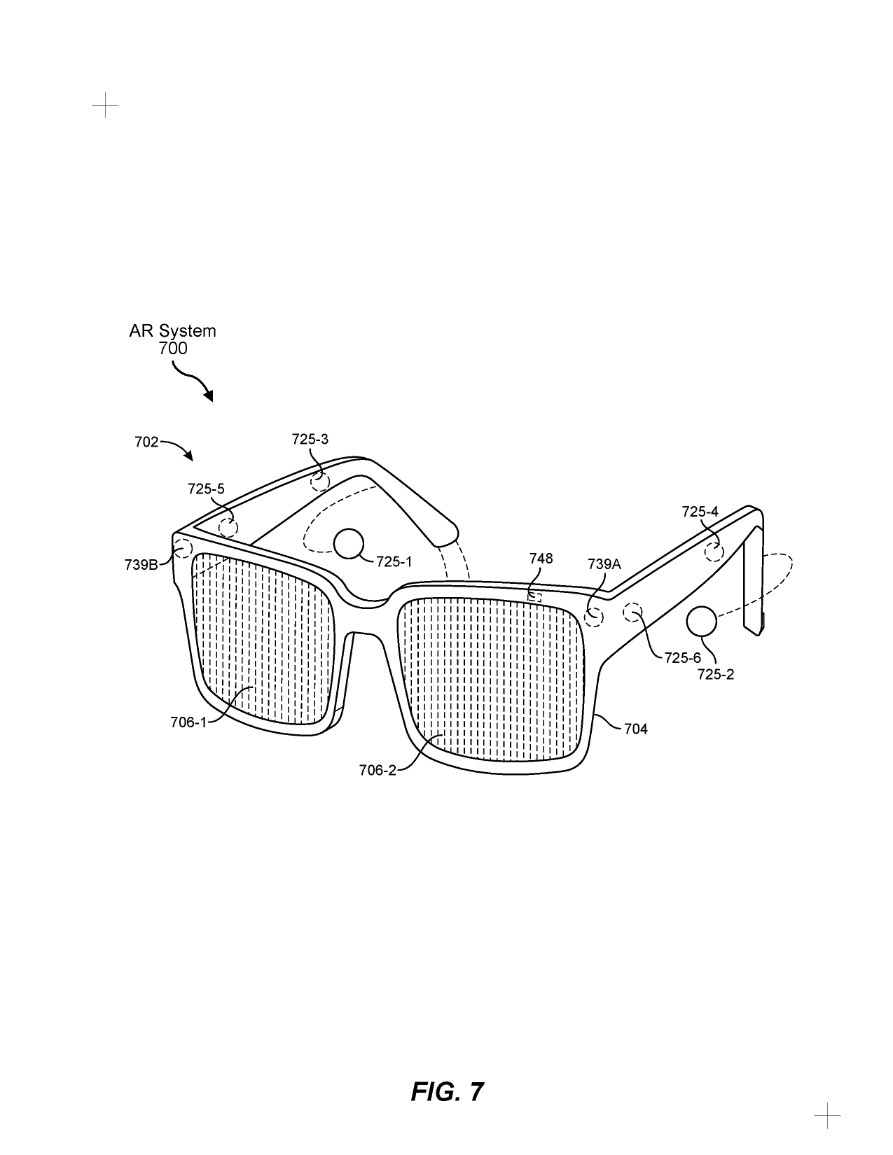

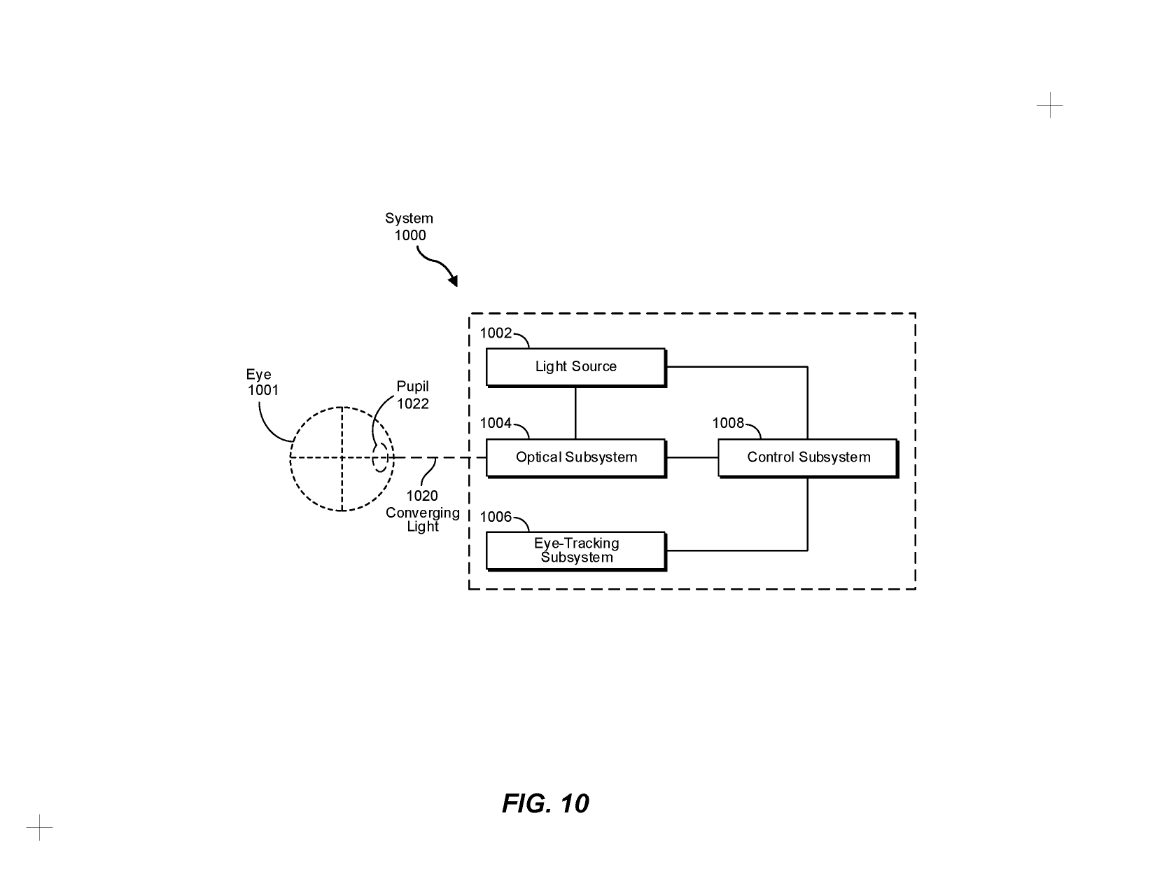

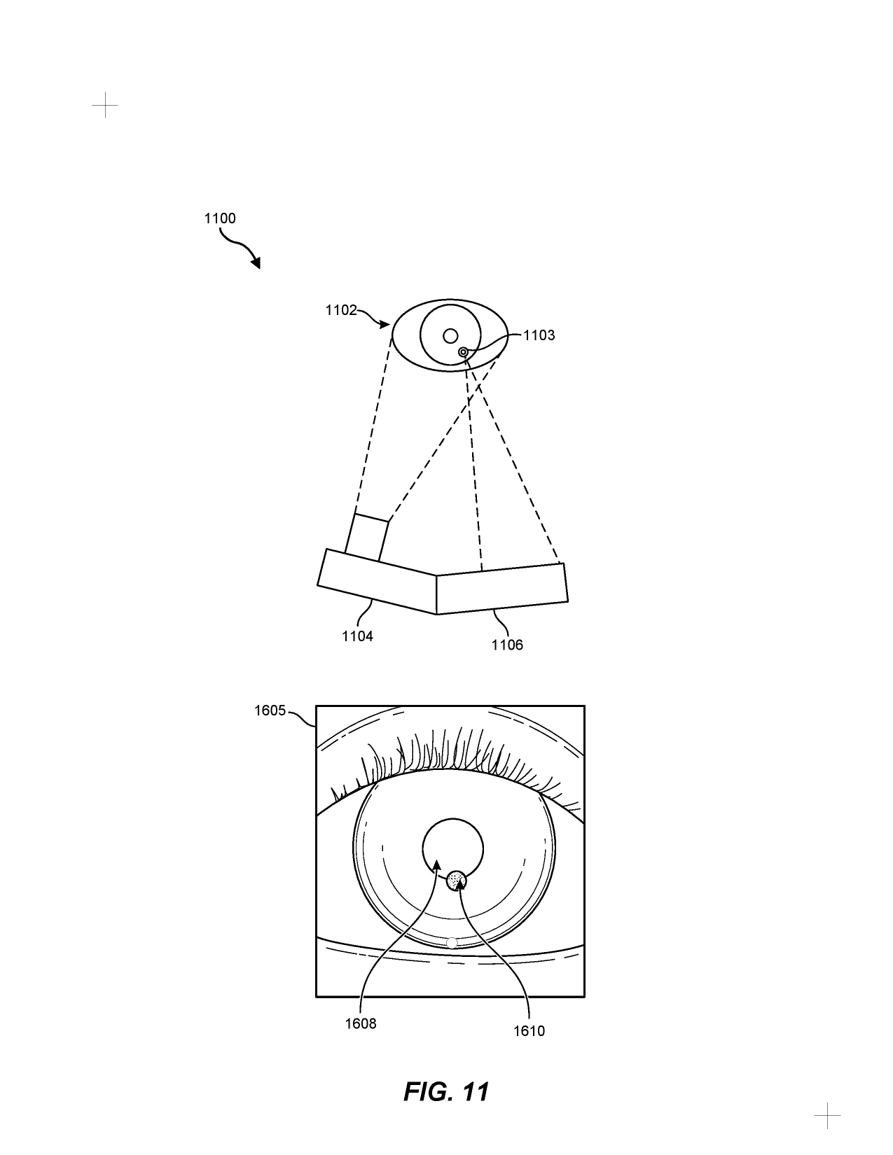

The following will provide, with reference to FIGS. 1-6, detailed descriptions of MEMS devices for eye tracking and related methods. Detailed descriptions of related AR/VR devices and systems are provided with reference to FIGS. 7-9. Detailed descriptions of related eye tracking subsystems are provided with reference to FIGS. 10 and 11.

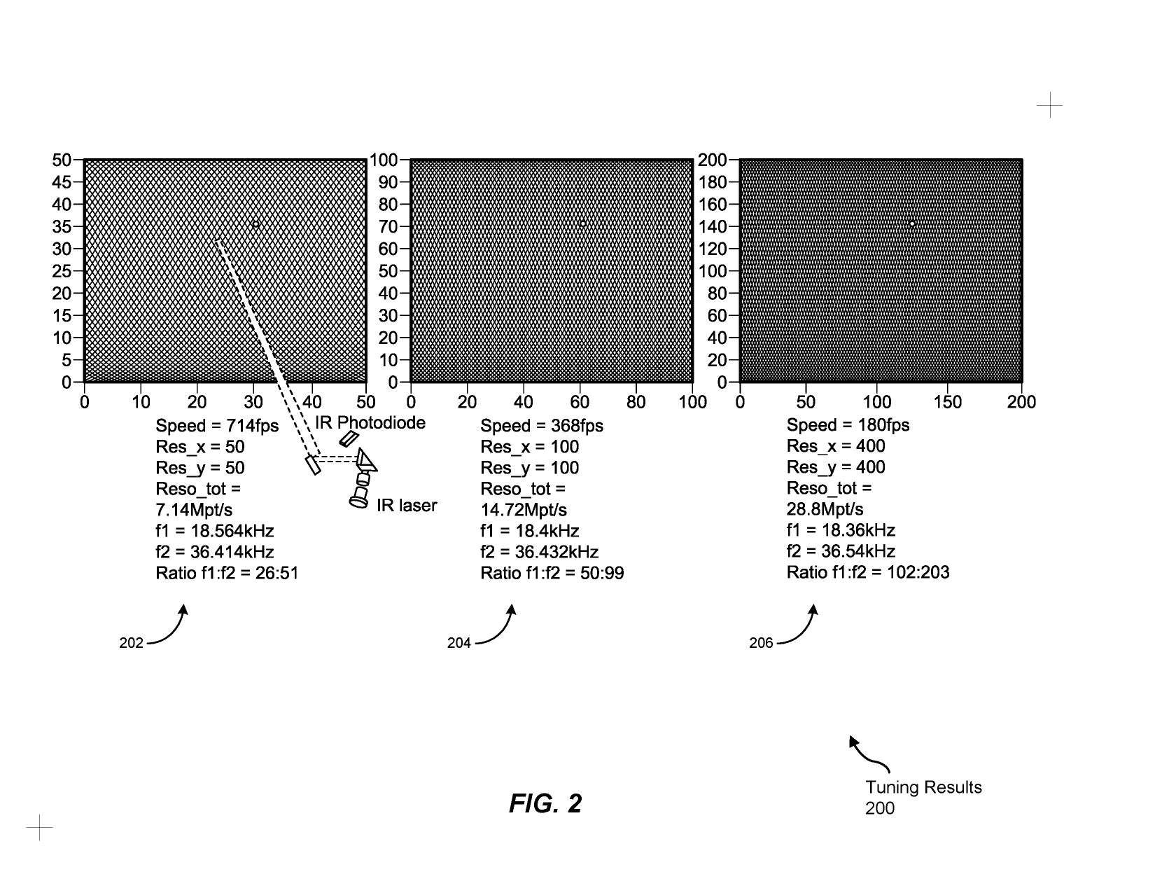

FIG. 1 is a flow diagram of an exemplary computer-implemented method 100 for operating a MEMS device for eye tracking. The steps shown in FIG. 1 may be performed by any suitable computer-executable code and/or computing system, including the system(s) illustrated in FIGS. 2-11. In one example, each of the steps shown in FIG. 1 may represent an algorithm whose structure includes and/or is represented by multiple sub-steps, examples of which will be provided in greater detail below.

As illustrated in FIG. 1, at step 110 one or more of the systems described herein may control a mirror. For example, method 100, at step 110, may oscillate a micro-electromechanical systems (MEMS) mirror at a first resonant frequency about a first axis and at a second resonant frequency about a second axis.

The term “MEMS mirror,” as used herein, a MEMS mirror may generally refer to a miniature reflective device that uses microelectromechanical systems (MEMS) technology to steer or modulate light beams with exceptional precision. For example, and without limitation, these mirrors may be fabricated on silicon substrates and integrate a reflective element with a micro-scale actuator (e.g., electromagnetic or electrostatic) that finely controls the mirror’s position, allowing for rapid and highly controlled angular deflections.

The term “resonant frequency,” as used herein, may generally refer to a specific frequency at which a system naturally oscillates with the greatest amplitude due to the constructive interference of energy. When an external force or signal matches this frequency, the system absorbs energy efficiently, resulting in pronounced oscillations. This phenomenon occurs in various physical systems, such as mechanical structures, electrical circuits, and acoustic environments. The resonant frequency is determined by the inherent properties of the system, including its mass, stiffness, and damping characteristics. In practical applications, understanding and controlling resonant frequency is crucial for optimizing performance, preventing unwanted vibrations, and designing systems for specific frequency responses.

The term “axis,” as used herein, may generally refer to an imaginary or physical straight line around which an object, system, or coordinate space is symmetrically arranged or rotates. For example, and without limitation, in geometry and physics, an axis often serves as a reference for measuring position, orientation, or movement, and is fundamental in defining coordinate systems such as Cartesian, cylindrical, or spherical coordinates. The properties and behavior of a system can be described relative to one or more axes, which may represent directions such as length, width, and height, or rotational movement such as pitch, yaw, and roll. In practical applications, identifying and utilizing axes is essential for analyzing motion, designing mechanical components, and understanding spatial relationships within various scientific and engineering disciplines. In this context, axes of a MEMS mirror refer to the imaginary or physical straight lines about which the mirror can rotate or move within its operational environment. Typically, a MEMS mirror is designed to pivot around one or more axes to achieve precise angular displacement, enabling the redirection of light or other signals in applications such as optical switching, beam steering, or scanning systems. These axes are fundamental in determining the mirror’s degrees of freedom, such as tilt along the x-axis and y-axis, which correspond to pitch and yaw movements, respectively. The orientation and configuration of the axes may impact the mirror’s performance, as they influence the range, speed, and accuracy of its motion. In practical terms, understanding and controlling the axes of a MEMS mirror may impact its functionality in devices that require high-speed, high-precision optical manipulation.

The term “oscillate,” as used herein, may generally refer to movement or variation in a regular, repetitive manner around a central point or between two or more states. For example, and without limitation, this motion or fluctuation can occur in physical objects, such as a pendulum swinging back and forth, or in abstract systems, such as electrical signals alternating between high and low values. Oscillation is characterized by its periodicity, meaning the movement or change repeats at consistent intervals over time. The concept is fundamental in many scientific and engineering disciplines, where it describes behaviors ranging from mechanical vibrations and sound waves to alternating currents and biological rhythms. In the context of a MEMS mirror, to oscillate may mean to move or rotate back and forth around a central position or axis in a periodic manner. This motion is typically driven by an external stimulus, such as an electrical signal, which causes the mirror to repeatedly tilt or pivot between two or more positions. Oscillation enables the MEMS mirror to dynamically redirect light or other signals with high speed and precision, making it applicable to optical scanning, beam steering, and signal modulation. The characteristics of the oscillation, including its frequency, amplitude, and stability, directly affect the performance and accuracy of the MEMS mirror in its intended application.

The systems described herein may perform step 110 in a variety of ways. In one example, the first axis and the second axis may be perpendicular to one another. Additionally, an X axis of the MEMS mirror may provide a field of view of fifty-two degrees with a frequency of 16.33 kHz, a peak to peak voltage of sixty volts, and a direct current voltage of thirty volts. Also, a Y axis of the MEMS mirror may provide a field of view of sixty degrees with a frequency of 31 kHz, a peak to peak voltage of twenty-eight volts, and a direct current voltage of fourteen volts. Further, neither the X axis nor the Y axis of the MEMS mirror may require differential driving or a vacuum environment. In any of these contexts, the repetition rate may be at least 100 times per second, the first resonant frequency may be more than 18 kHz, and/or the second resonant frequency may be more than 36 KHz.

As illustrated in FIG. 1, at step 120 one or more of the systems described herein may direct light. For example, method 100, at step 120, may direct light from a laser light source to the MEMS mirror to reflect from the MEMS mirror toward a user’s eye for illumination of the user’s eye, wherein the MEMS mirror is configured to illuminate the user’s eye in a scanning pattern that repeats at a rate.

The term “laser light source,” as used herein, may generally refer to a device that emits light through a process known as stimulated emission, producing a highly focused and coherent beam. For example, and without limitation, unlike conventional light sources, a laser generates light that is monochromatic, meaning it consists of a single wavelength or color, and is directional, allowing it to travel long distances with minimal divergence. The coherence and intensity of laser light make it ideal for applications requiring precision and control, such as optical communication, medical procedures, material processing, and scientific research. The operation of a laser light source typically involves an active medium, an energy supply, and optical components that amplify and direct the emitted light, resulting in a beam with unique properties not found in ordinary light sources.

The term “scanning pattern,” as used herein, may generally refer to a specific trajectory or sequence of movements that a MEMS mirror follows to redirect a light beam or signal across a target area. For example, and without limitation, this pattern may be determined by the controlled oscillation or rotation of the mirror around its axes, enabling the light to sweep over a surface in a predetermined manner, such as linear, circular, or raster paths. The scanning pattern is applicable to imaging, projection, and optical sensing, where precise and repeatable coverage of an area may be beneficial. The design and control of the scanning pattern directly influence the resolution, speed, and effectiveness of the MEMS mirror in its intended function.

The term “rate,” as used herein, may generally refer to a frequency at which a MEMS mirror completes its scanning cycle over a target area within a given period of time. For example, and without limitation, the rate may indicate how many times the mirror repeats its full scanning pattern, such as a sweep or oscillation, per second or another unit of time. The rate may be a parameter in determining the speed and temporal resolution of the system, as a higher repetition rate allows for faster coverage and more frequent updates of the scanned area. In practical applications, controlling the rate may determine the performance of the MEMS mirror in tasks like imaging, projection, and sensing, where timely and accurate scanning may be beneficial.

The systems described herein may perform step 120 in a variety of ways. For example, the laser light source may correspond to a VCSEL that emits a laser beam through a beam shaping optic (e.g., lens, meta lens, diffractive optic, etc.) onto an optical element (e.g., a reflector or a polarizing beam splitter) that redirects the light onto the MEMS mirror. Light reflected from the MEMS mirror may then exit an optical window (e.g., a transparent material, a quarter wave plate, etc.) and illuminate a user’s eye.

As illustrated in FIG. 1, at step 130 one or more of the systems described herein may tune a rate. For example, method 100, at step 130, may tune the rate of the scanning pattern by altering a ratio of the first resonant frequency and the second resonant frequency within a range of 1.0:1.8 to 1.0:2.2.

The term “tune,” as used herein, may generally refer to a process of adjusting or modifying operational parameters of a MEMS mirror to achieve a desired frequency at which the MEMS mirror completes its scanning pattern. For example, and without limitation, this adjustment can involve changing the input signals, control voltages, or mechanical properties that influence the mirror’s oscillation or rotation. Tuning allows for precise control over how quickly and how often the mirror repeats its movement across the target area, enabling optimization for specific applications such as imaging, projection, or sensing. By tuning the repetition rate, users can enhance system performance, adapt to varying operational requirements, and ensure that the MEMS mirror functions efficiently within its intended environment.

The term “ratio,” as used herein, may generally refer to a quantitative relationship between the oscillation frequencies around two or more axes. For example, and without limitation, this ratio may typically be expressed as a fraction or proportion, indicating how many times a MEMS mirror oscillates about one axis compared to another within the same time period. The ratio of frequencies may correspond to a parameter in determining the overall scanning pattern, as it affects the trajectory and coverage of the light beam or signal redirected by the MEMS mirror. By controlling the ratio, designers can tailor the movement of the MEMS mirror to achieve specific patterns, resolutions, and operational characteristics suited to applications such as imaging, projection, or optical sensing.

The term “range,” as used herein, may generally refer to a span or interval of possible values that a ratio between oscillation frequencies can take. For example, and without limitation, this range may define the limits within which the ratio may be adjusted or varied, allowing for different combinations of movement along the mirror’s axes. The range of ratios may determine the flexibility and adaptability of the MEMS mirror’s scanning patterns, enabling the system to accommodate various operational requirements and application-specific needs. By specifying a range, designers and users can ensure that the MEMS mirror can be tuned to produce a variety of scanning trajectories, resolutions, and coverage areas, thereby enhancing its versatility and performance in tasks such as imaging, projection, and optical sensing.

The systems described herein may perform step 130 in a variety of ways. For example, a computing system (e.g., at least one physical processor (e.g., an application specific integrated circuit (ASIC))) may dynamically tune the ratio while the MEMS mirror is oscillated at step 110 and the light is directed in step 120. In some implementations, the computing system may also perform the oscillation of the MEMS mirror and/or cause the laser source to emit the light. In some implementations, the computing system may receive a signal from a light detector configured to detect light reflected from the user’s eye and determine a gaze direction of the user’s eye based on the signal. Additional options and other details relating to steps 110-130 of method 100 are provided below with reference to FIGS. 2-11.

FIG. 2 is a graphical illustration of exemplary results 200 obtained by tuning a repetition rate of a MEMS mirror of a MEMS device for eye tracking (e.g., according to the method 100 of FIG. 1). For example, control parameters for a MEMS mirror, such as scanning speed and X/Y resolution, may be adjusted by tuning a ratio of frequencies employed to oscillate a MEMS mirror in respective axes. In this context, results of applying frequency pairs with various ratios are shown in FIG. 2.

As shown in FIG. 2, a first scanning pattern 202 is shown in which a first frequency of 18.564 kHz and a second frequency 36.414 kHZ are applied. Application of this frequency pair may achieve a scanning speed of 714 frames per second (fps), an X axis resolution of 50 points, a Y axis resolution of 50 points, and a total resolution of 7.14 mega points per second. In this case, a ratio of the first frequency to the second frequency corresponds to 26:51.

As shown in FIG. 2, a second scanning pattern 204 is shown in which a first frequency of 18.4 kHz and a second frequency 36.432 kHZ are applied. Application of this frequency pair may achieve a scanning speed of 368 fps, an X axis resolution of 100 points, a Y axis resolution of 100 points, and a total resolution of 14.72 mega points per second. In this case, a ratio of the first frequency to the second frequency corresponds to 50:99.

As shown in FIG. 2, a third scanning pattern 206 is shown in which a first frequency of 18.36 kHz and a second frequency 36.54 kHZ are applied. Application of this frequency pair may achieve a scanning speed of 180 fps, an X axis resolution of 400 points, a Y axis resolution of 400 points, and a total resolution of 28.8 mega points per second. In this case, a ratio of the first frequency to the second frequency corresponds to 102:203.

As shown in FIG. 2, these three frequency pairs offer scanning options that provide a tradeoff between scanning speed and resolution. A computing system may dynamically apply these or other frequency pairs while oscillating a MEMS mirror to achieve dynamic change in the imaging frame rate and resolution, leveraging the frequency tunability of the MEMS mirror in its two resonant axes. In doing so, the applied frequency pairs may have a ratio that lies within a range. For example, in scanning pattern 202, a ratio of the first frequency to the second frequency corresponds to approximately 1.00:1.96. Additionally, in scanning pattern 204, a ratio of the first frequency to the second frequency corresponds to approximately 1.00:1.98. Also, in scanning pattern 206, a ratio of the first frequency to the second frequency corresponds to approximately 1.00:1.99. These approximate ratios, as rounded off, lie within a range of 1.00:1.96 to 1.00:1.99. More precisely, these ratios lie within a range of 1.000:1.960 to 1.000:1.995.

As may be appreciated from the foregoing, the rate of the scanning pattern is tunable by altering a ratio of the first resonant frequency (e.g., applicable to the X axis) to the second frequency (e.g., applicable to the Y axis) within a range. In one example, the range may be 1.0:1.8 to 1.0:2.2. In another example, the range may be 1.0:1.9 to 1.0:2.1. In another example, the range may be 1.0:1.95 to 1.0:2.05. In another example, the range may be 1.00:1.95 to 1.00:2.00. In another example, the range may be 1.000:1.960 to 1.000:1.995.

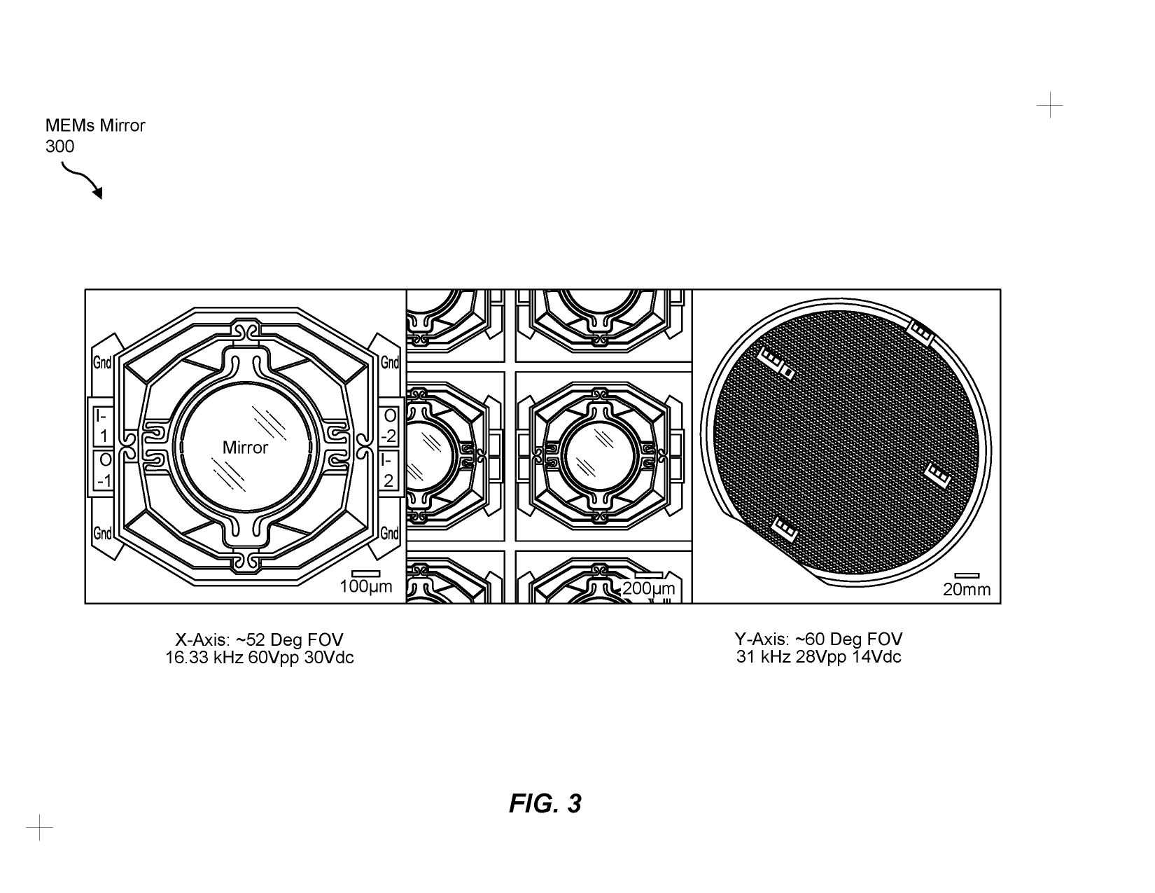

FIG. 3 is a graphical illustration of an exemplary MEMS mirror 300 of a MEMS device for eye tracking. For example, and as mentioned above, the MEMS mirror 300 may have a first axis and a second axis that are perpendicular to one another. Additionally, an X axis of the MEMS mirror may provide a field of view of fifty-two degrees with a frequency of 16.33 kHz, a peak to peak voltage of sixty volts, and a direct current voltage of thirty volts. Also, a Y axis of the MEMS mirror may provide a field of view of sixty degrees with a frequency of 31 kHz, a peak to peak voltage of twenty-eight volts, and a direct current voltage of fourteen volts. Further, neither the X axis nor the Y axis of the MEMS mirror may require differential driving or a vacuum environment. As a result of such high stress mitigation designs of the MEMS mirror, high resonant frequencies may be achieved through large actuation force.

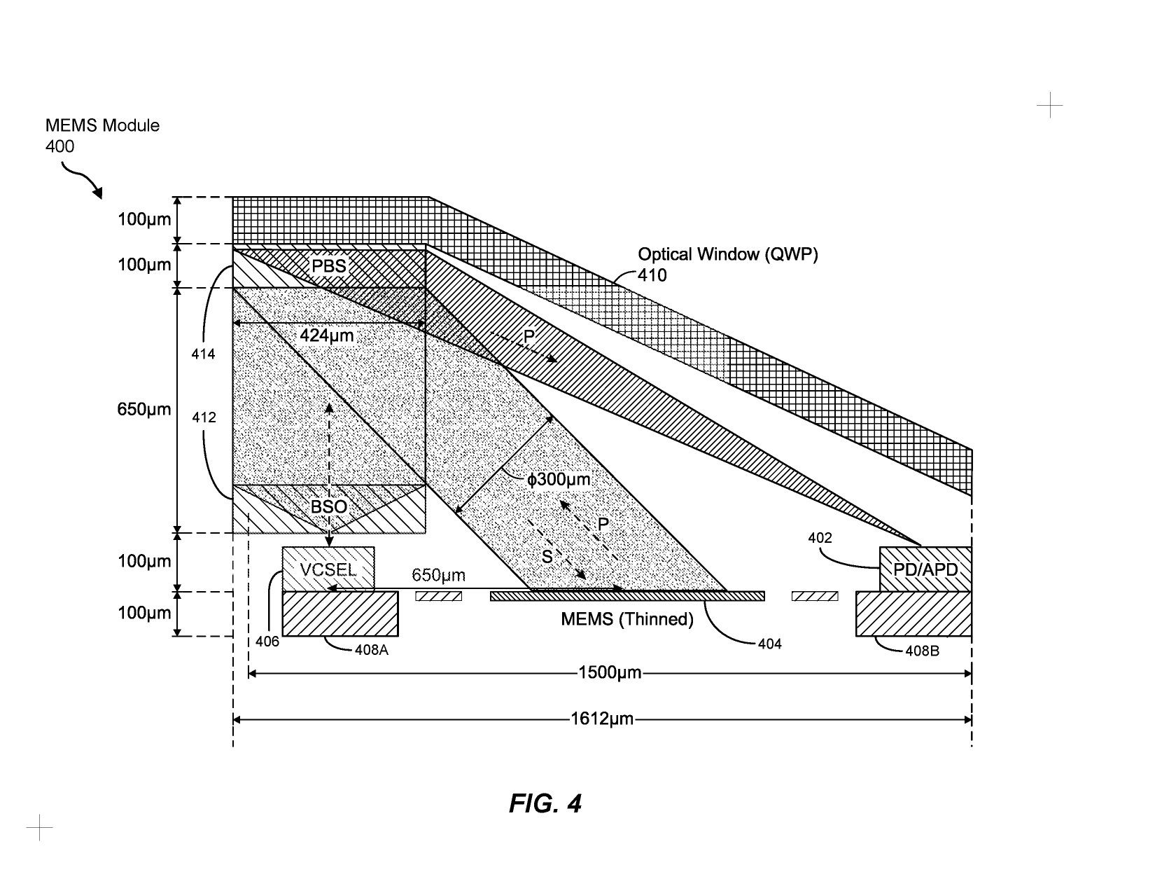

FIG. 4 illustrates an exemplary integrated MEMS module 400 that includes a light detector 402 and that may be configured to operate in accordance with method 100 of FIG. 1. For example, MEMS module 400 may include a MEMS mirror 404 configured to oscillate at a first resonant frequency about a first axis and at a second resonant frequency about a second axis. Additionally, MEMS module 400 may include a laser light source 406 configured to direct light to the MEMS mirror 404 to reflect from the MEMS mirror 404 toward a user’s eye for illumination of the user’s eye. Also, the MEMS mirror 404 may be configured to illuminate the user’s eye in a scanning pattern that can repeat at a rate, and the rate of the scanning pattern may be tunable by altering a ratio of the first resonant frequency and the second resonant frequency within a range of 1.0:1.8 to 1.0:2.2. In some implementations, the rate may be at least 100 times per second. Alternatively or additionally, the first resonant frequency may be more than 18 kHz and the second resonant frequency may be more than 36 KHz.

As shown in FIG. 4, MEMS module 400 may include additional components. For example, MEMS module 400 may include a support substrate 408A and 408B that supports the MEMS mirror 404. Additionally, the laser light source 406 may be mounted to the support substrate. Similarly, the light detector 402 may be mounted to the support substrate (e.g., on an opposite side of the MEMS module 400 from the laser source 406). In some implementations, the light detector 402 may be configured to detect a two-dimensional image of the user’s eye. Also, a computing system (e.g., described later with reference to FIGS. 7-11) may be configured to receive a signal from the light detector 402 and to determine a gaze direction of the user’s eye based on the signal.

As shown in FIG. 4, the support substrate and MEMS mirror 404 may have a size of 1.5 mm by 1.5 mm or less, and an overall size of the MEMS module 400 may be 1.612 mm by 1.612 mm or less. Dimensions shown in FIG. 4 are exemplary; a size of the MEMS module 400 may be scaled up or down. However, the dimensions shown in FIG. 4 represent an improvement in form factor for an AR/VR MEMS scanning eye tracker and for an eye tracking (ET) system.

As shown in FIG. 4, an optical window 410 may be positioned over the MEMS mirror 404 and be oriented at an angle to the MEMS mirror 404. The angle of the optical window 410 may lie in a range that reduces or minimizes light back-reflecting off of the window 410 to the detector 402, while allowing scanning light from the MEMS mirror 404 to pass toward the eye. In some implementations, the optical window 410 may include a quarter wave plate that alters a polarization state of light passing through the optical window 410. Also, a beam shaping optic 412 may be configured to focus the light from the laser light source 406 onto a polarization beam splitter 414. For example, the polarization beam splitter may include a lens, a meta lens, or a diffractive optic. In some implementations, the polarization beam splitter 414 may be configured to redirect light from the laser light source 406 to the MEMS mirror 404 and from the MEMS mirror 404 to the light detector 402. In some instances, MEMS module 400 may include an additional beam shaping optic configured to focus light from the polarization beam splitter 414 onto the light detector 402, and this additional beam shaping optic may be formed into the polarization beam splitter 414 in some examples.

As shown in FIG. 4, light may be emitted by the laser source 406 through beam shaping optic 412 to polarization beam splitter 414. In turn, polarization beam splitter 414 may redirect the light onto MEMS mirror 404 with a first polarization S. Next, the light may be reflected from the MEMS mirror through the optical window 410 onto a user’s eye. Light reflected from the user’s eye may then return through the optical window 410 with a second polarization P imparted by a quarter wave plate included in the optical window 410 and impinge upon MEMS mirror 404. MEMS mirror 404 may then direct the reflected light onto polarization beam splitter 414. Due to the second polarization P of the reflected light, the polarization beam splitter 414 may redirect the reflected light onto the light detector 402. Light detector 402 may be tailored to detect light of polarization P to identify light reflecting from the eye, as distinguished from light of polarization S from the laser source. For single pixel imaging, the image distance may be folded or eliminated (e.g., lensless imaging), and the imaging height may be reduced due to single pixel imaging.

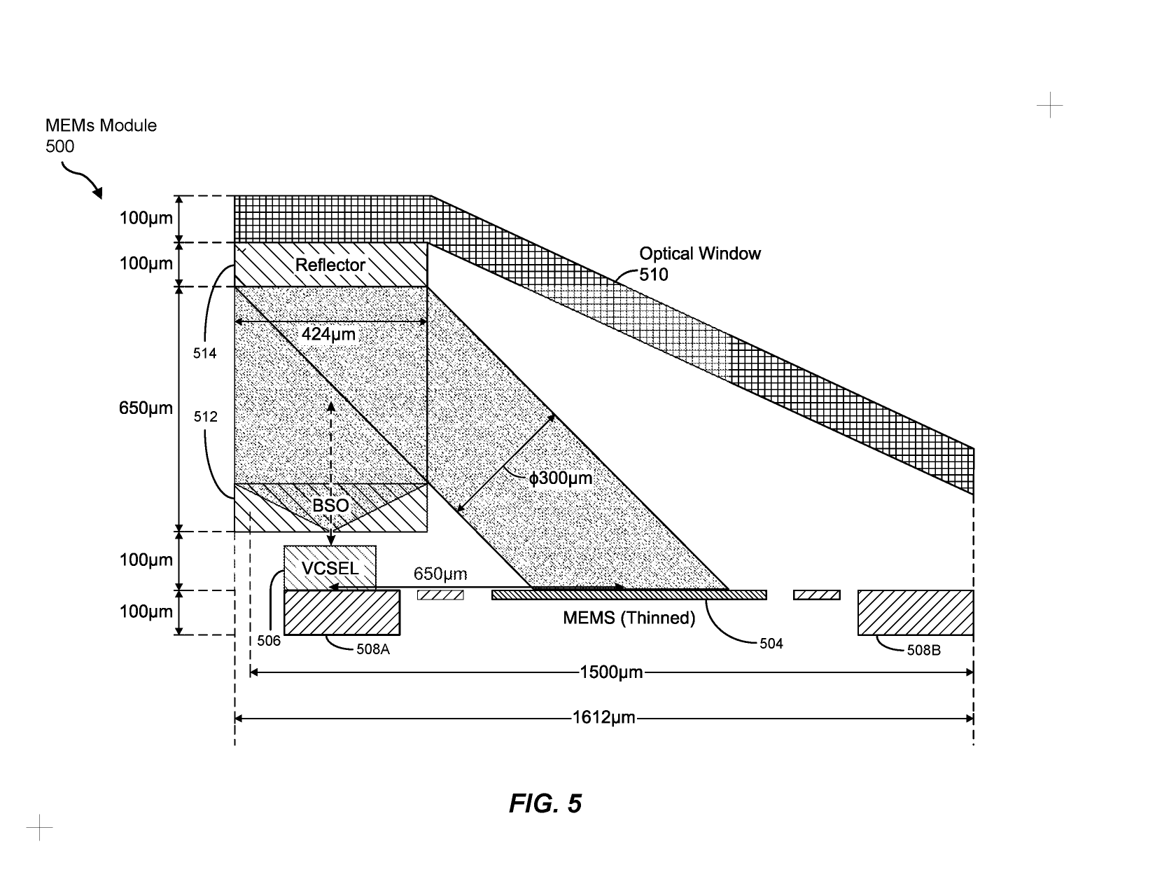

FIG. 5 illustrates an exemplary illumination-only integrated MEMS module 500 that may be configured to operate in accordance with method 100 of FIG. 1. MEMS module 500 may be similar to MEMS module 400 of FIG. 4 except in a few respects. For example, MEMS module 500 may not include a light detector. Additionally, MEMS module 500 may include a reflector 514 instead of a polarization beam splitter. Also, MEMS module 500 may include an optical window 510 that may not include a quarter wave plate.

As shown in FIG. 5, MEMS module 500 may include a MEMS mirror 504 configured to oscillate at a first resonant frequency about a first axis and at a second resonant frequency about a second axis. Additionally, MEMS module 500 may include a laser light source 506 configured to direct light to a MEMS mirror 504 to reflect from the MEMS mirror 504 toward a user’s eye for illumination of the user’s eye. Also, the MEMS mirror 504 may be configured to illuminate the user’s eye in a scanning pattern that can repeat at a rate, and the rate of the scanning pattern may be tunable by altering a ratio of the first resonant frequency and the second resonant frequency within a range of 1.0:1.8 to 1.0:2.2. In some implementations, the rate may be at least 100 times per second. Alternatively or additionally, the first resonant frequency may be more than 18 kHz and the second resonant frequency may be more than 36 KHz.

As shown in FIG. 5, MEMS module 500 may include additional components. For example, MEMS module 500 may include a support substrate 508A and 508B that supports the MEMS mirror 504. Additionally, the laser light source 506 may be mounted to the support substrate. The support substrate and MEMS mirror 504 may have a size of 1.5 mm by 1.5 mm or less, and an overall size of the MEMS module 500 may be 1.612 mm by 1.612 mm or less. Dimensions shown in FIG. 5 are exemplary; a size of the MEMS module 500 may be scaled up or down. However, the dimensions shown in FIG. 5 represent an improvement in form factor for an AR/VR MEMS scanning eye tracker and for an eye tracking (ET) system.

As shown in FIG. 5, an optical window 510 may be positioned over the MEMS mirror 504 and be oriented at an angle to the MEMS mirror 504. Also, a beam shaping optic 512 may be configured to focus the light from the laser light source 506 onto a reflector 514. In some implementations, the reflector 514 may be configured to redirect light from the laser light source 506 to the MEMS mirror 504. Light may be emitted by the laser source 506 through beam shaping optic 512 to reflector 514. In turn, reflector 514 may redirect the light onto MEMS mirror 504. Next, the light may be reflected from the MEMS mirror 504 through the optical window 510 onto a user’s eye.

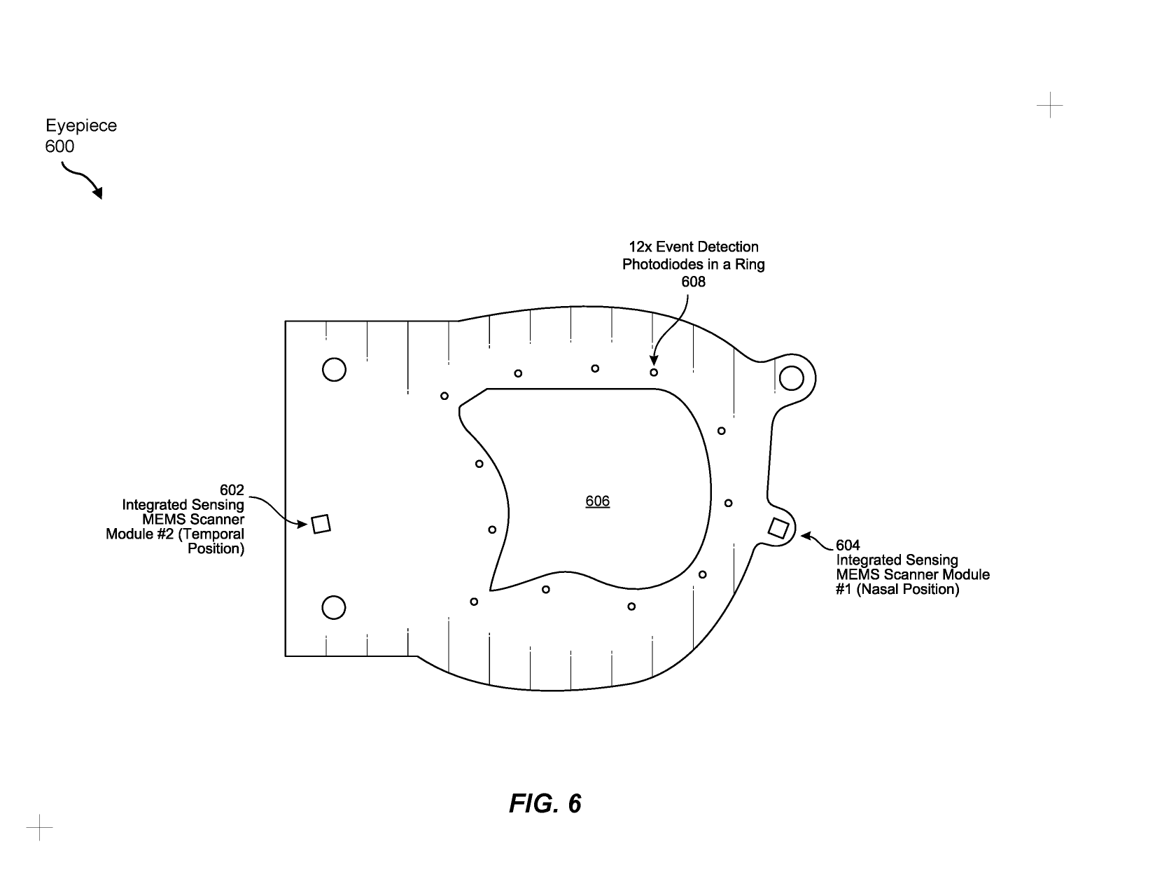

FIG. 6 illustrates an exemplary MEMS scanning eye tracking eyepiece 600 having MEMS devices 602 and 604 integrated therein. MEMS devices 602 and 604 shown in FIG. 6 both correspond to integrated sensing MEMS scanner modules having light detectors integrated therein like module 400 shown in FIG. 4. However, MEMS devices 602 and 604 may correspond to MEMS module 400 of FIG. 4, MEMS module 500 of FIG. 5, and/or any MEMS device that operates in accordance with method 100 of FIG. 1.

As shown in FIG. 6, MEMS devices 602 and 604 may be integrated into eyepiece 600 at temporal and nasal positions, respectively. Additionally, eyepiece 600 may include an aperture 606 about which a plurality of detection photodiodes 608 are arranged. These photodiodes 608, in addition to any light detectors included in MEMS devices 602 and 604, may receive light emitted by the MEMS devices 602 and 604 and reflected from a user’s eye. As mentioned previously, a computing system, detailed later herein with reference to FIGS. 7-11, may communicate with photodiodes 608 and MEMS devices 602 and 604. This computing system may control MEMS devices 602 and/or 604 to oscillate a MEMS mirror, cause a laser light source to emit light, and tune a rate at which a scanning pattern repeats. Additionally, this computing system may receive signals from photodiodes 608 and/or light detectors and determine a gaze direction of the user’s eye based on the signals.

As set forth above, embodiments of the present disclosure may oscillate a MEMS mirror at a first resonant frequency about a first axis and at a second resonant frequency about a second axis. Light may be directed from a laser light source to the MEMS mirror to reflect from the MEMS mirror toward a user’s eye for illumination of the user’s eye. A rate of a scanning pattern of the MEMS mirror may be tuned by altering a ratio of a first resonant frequency and a second resonant frequency within a range of 1.0:1.8 to 1.0:2.2. In this way, the MEMS mirror is configured to illuminate the user’s eye in a scanning pattern that repeats at the rate. Moreover, different frequency pairs used for the tuning may achieve dynamic change in the imaging frame rate and resolution, thus leveraging the frequency tunability of the MEMS mirror in its two resonant axes.

Benefits achieved by the disclosed systems and methods relate to improvements in achieving an AR/VR form factor MEMS scanning eye tracker, targeting for high speed, and a small form-factor eye tracking (ET) system. For example, the disclosed systems and methods achieve imaging speed and resolution requirements of the eye tracking application. The disclosed systems and methods achieve this capability using a high-speed MEMS in combination with a smaller form factor integration module. Additionally, the use of different frequency pairs allows dynamic change in the imaging frame rate and resolution, leveraging the frequency tunability of the MEMS mirror in its two resonant axes. Also, the high resonant frequency may be achieved through large actuation force and high stress mitigation designs of the MEMS mirror. Moreover, integrated MEMS illumination and sensing may leverage the heterogeneous integration of MEMS and laser (e.g., vertical-cavity surface-emitting laser (VCSEL) and detector (e.g. avalanche photodiodes (APD))) on the surface on the MEMS die. In this context, the MEMS may function in the module both as the scanner and the sub-mount for both the laser and the detector. Necessary routing for electrical connection and data readout may be achieved through additional routing on the MEMS device. Further, a tilted window may be specially designed to guarantee both large FOV without occlusion and less back reflection into the inner cavity of the module.

### Example Embodiments

Example 1: An apparatus may include a micro-electromechanical systems (MEMS) mirror configured to oscillate at a first resonant frequency about a first axis and at a second resonant frequency about a second axis, and a laser light source configured to direct light to the MEMS mirror to reflect from the MEMS mirror toward a user’s eye for illumination of the user’s eye, wherein the MEMS mirror is configured to illuminate the user’s eye in a scanning pattern that can repeat at a rate, and the rate of the scanning pattern is tunable by altering a ratio of the first resonant frequency and the second resonant frequency within a range of 1.0:1.8 to 1.0:2.2.

Example 2: The apparatus of Example 1, wherein the rate is at least 100 times per second.

Example 3: The apparatus of Example 1 or Example 2, wherein the first resonant frequency is more than 18 kHz and the second resonant frequency is more than 36 KHz.

Example 4: The apparatus of any of Examples 1 to 3, further including a support substrate that supports the MEMS mirror.

Example 5: The apparatus of any of Examples 1 to 4, wherein the laser light source is mounted to the support substrate.

Example 6: The apparatus of any of Examples 1 to 5, further including a light detector mounted to the support substrate.

Example 7: The apparatus of any of Examples 1 to 6, further including a computing system configured to receive a signal from the light detector and to determine a gaze direction of the user’s eye based on the signal.

Example 8: The apparatus of any of Examples 1 to 7, wherein the light detector is configured to detect a two-dimensional image of the user’s eye.

Example 9: Example 5: The apparatus of any of Examples 1 to 8, wherein the support substrate and MEMS mirror has a size of 1.6 mm by 1.6 mm or less.

Example 10: The apparatus of any of Examples 1 to 9, further including an optical window positioned over the MEMS mirror, the optical window oriented at an angle to the MEMS mirror.

Example 11: The apparatus of any of Examples 1 to 10, wherein the optical window comprises a quarter wave plate that alters a polarization state of light passing through the optical window.

Example 12: The apparatus of any of Examples 1 to 11, further including a beam shaping optic configured to focus the light from the laser light source onto at least one of a polarization beam splitter or a reflector.

Example 13: The apparatus of any of Examples 1 to 12, wherein the beam shaping optic corresponds to a lens, a meta lens, and/or a diffractive optic.

Example 14: The apparatus of any of Examples 1 to 13, further including a polarization beam splitter configured redirect light from the laser light source to the MEMS mirror and from the MEMS mirror to a light detector.

Example 15: The apparatus of any of Examples 1 to 14, further including a beam shaping optic configured to focus light from the polarization beam splitter onto the light detector.

Example 16: A system may include an eye tracking eye piece having an aperture, a plurality of detection photodiodes arranged about the aperture, and a sensing micro-electromechanical systems (MEMS) scanner module integrated into the eye tracking eye piece, wherein the MEMS scanner module includes a MEMS mirror configured to oscillate at a first resonant frequency about a first axis and at a second resonant frequency about a second axis, and a laser light source configured to direct light to the MEMS mirror to reflect from the MEMS mirror toward a user’s eye for illumination of the user’s eye, wherein the MEMS mirror is configured to illuminate the user’s eye in a scanning pattern that can repeat at a rate, and the rate of the scanning pattern is tunable by altering a ratio of the first resonant frequency and the second resonant frequency within a range of 1.0:1.8 to 1.0:2.2.

Example 17: The system of Example 16, wherein the sensing MEMS scanner module is integrated at a temporal position of the eye tracking eye piece, the system further including an additional sensing MEMS scanner module integrated at a nasal position of the eye tracking eye piece.

Example 18: A method may include oscillating a micro-electromechanical systems (MEMS) mirror at a first resonant frequency about a first axis and at a second resonant frequency about a second axis, directing light from a laser light source to the MEMS mirror to reflect from the MEMS mirror toward a user’s eye for illumination of the user’s eye, wherein the MEMS mirror is configured to illuminate the user’s eye in a scanning pattern that repeats at a rate, and tuning the rate of the scanning pattern by altering a ratio of the first resonant frequency and the second resonant frequency within a range of 1.0:1.8 to 1.0:2.2.

Example 19: The method of Example 18, further including receiving a signal from a light detector configured to detect light reflected from the user’s eye.

Example 20: The method of examples 18 or 19, further including determining a gaze direction of the user’s eye based on the signal.

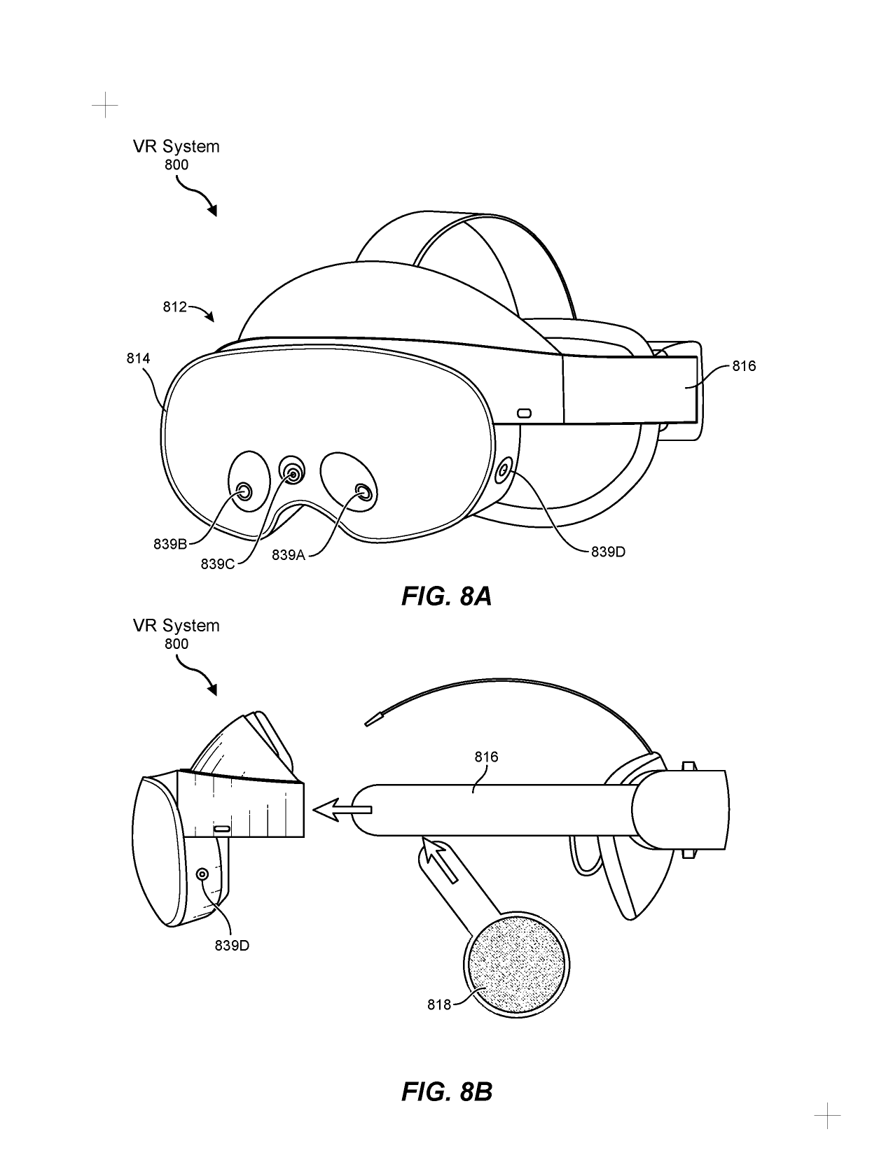

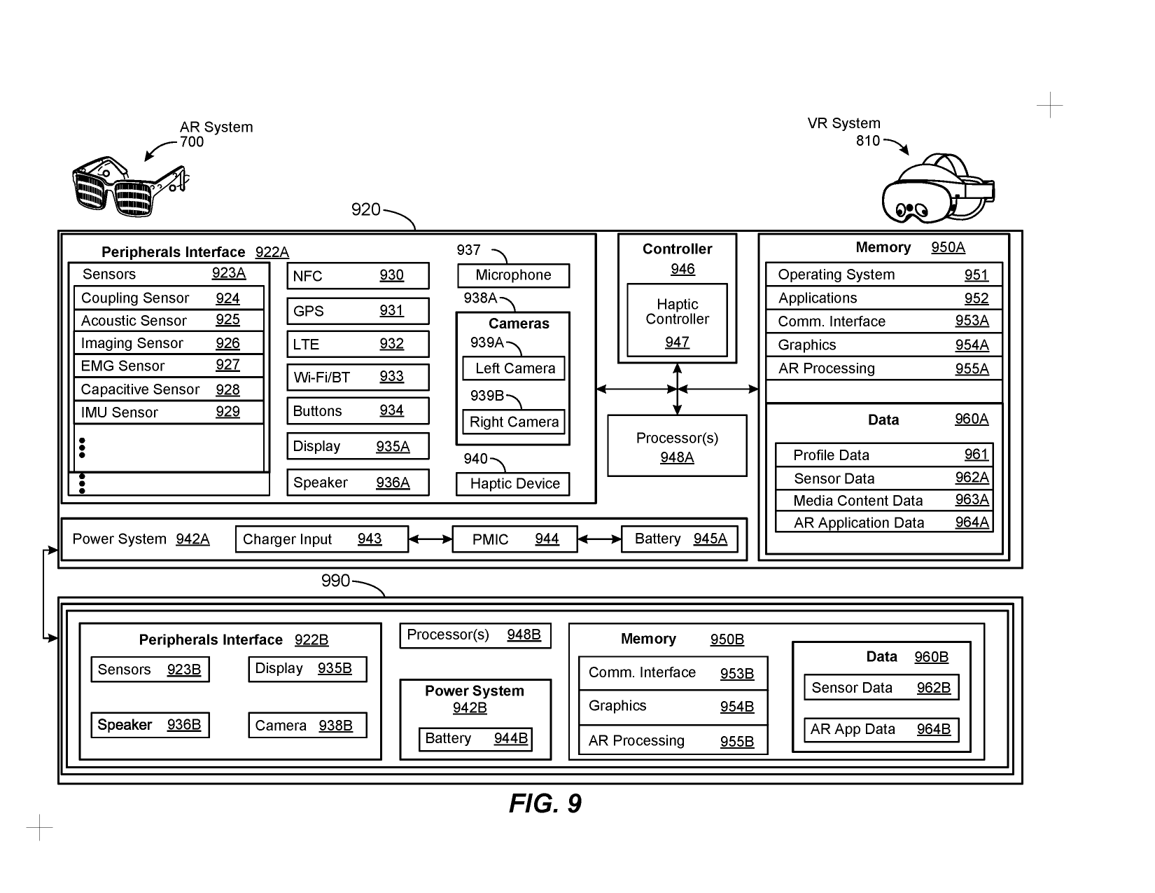

FIGS. 7 to 9 show example artificial-reality systems, which can be used as or in connection with a wrist-wearable device. In some embodiments, AR system 700 includes an eyewear device 702, as shown in FIG. 7. In some embodiments, VR system 810 includes a head-mounted display (HMD) 812, as shown in FIGS. 8A and 8B. In some embodiments, AR system 700 and VR system 810 can include one or more analogous components (e.g., components for presenting interactive artificial-reality environments, such as processors, memory, and/or presentation devices, including one or more displays and/or one or more waveguides), some of which are described in more detail with respect to FIG. 9. As described herein, a head-wearable device can include components of eyewear device 702 and/or head-mounted display 812. Some embodiments of head-wearable devices do not include any displays, including any of the displays described with respect to AR system 700 and/or VR system 810. While the example artificial-reality systems are respectively described herein as AR system 700 and VR system 810, either or both of the example AR systems described herein can be configured to present fully-immersive virtual-reality scenes presented in substantially all of a user’s field of view or subtler augmented-reality scenes that are presented within a portion, less than all, of the user’s field of view.

FIG. 7 show an example visual depiction of AR system 700, including an eyewear device 702 (which may also be described herein as augmented-reality glasses, and/or smart glasses). AR system 700 can include additional electronic components that are not shown in FIG. 7, such as a wearable accessory device and/or an intermediary processing device, in electronic communication or otherwise configured to be used in conjunction with the eyewear device 702. In some embodiments, the wearable accessory device and/or the intermediary processing device may be configured to couple with eyewear device 702 via a coupling mechanism in electronic communication with a coupling sensor 924 (FIG. 9), where coupling sensor 924 can detect when an electronic device becomes physically or electronically coupled with eyewear device 702. In some embodiments, eyewear device 702 can be configured to couple to a housing 990 (FIG. 9), which may include one or more additional coupling mechanisms configured to couple with additional accessory devices. The components shown in FIG. 7 can be implemented in hardware, software, firmware, or a combination thereof, including one or more signal-processing components and/or application-specific integrated circuits (ASICs).

Eyewear device 702 includes mechanical glasses components, including a frame 704 configured to hold one or more lenses (e.g., one or both lenses 706-1 and 706-2). One of ordinary skill in the art will appreciate that eyewear device 702 can include additional mechanical components, such as hinges configured to allow portions of frame 704 of eyewear device 702 to be folded and unfolded, a bridge configured to span the gap between lenses 706-1 and 706-2 and rest on the user’s nose, nose pads configured to rest on the bridge of the nose and provide support for eyewear device 702, earpieces configured to rest on the user’s ears and provide additional support for eyewear device 702, temple arms configured to extend from the hinges to the earpieces of eyewear device 702, and the like. One of ordinary skill in the art will further appreciate that some examples of AR system 700 can include none of the mechanical components described herein. For example, smart contact lenses configured to present artificial reality to users may not include any components of eyewear device 702.

Eyewear device 702 includes electronic components, many of which will be described in more detail below with respect to FIG. 7. Some example electronic components are illustrated in FIG. 7, including acoustic sensors 725-1, 725-2, 725-3, 725-4, 725-5, and 725-6, which can be distributed along a substantial portion of the frame 704 of eyewear device 702. Eyewear device 702 also includes a left camera 739A and a right camera 739B, which are located on different sides of the frame 704. Eyewear device 702 also includes a processor 748 (or any other suitable type or form of integrated circuit) that is embedded into a portion of the frame 704.

FIGS. 8A and 8B show a VR system 810 that includes a head-mounted display (HMD) 812 (e.g., also referred to herein as an artificial-reality headset, a head-wearable device, a VR headset, etc.), in accordance with some embodiments. As noted, some artificial-reality systems (e.g., AR system 700) may, instead of blending an artificial reality with actual reality, substantially replace one or more of a user’s visual and/or other sensory perceptions of the real world with a virtual experience (e.g., AR systems).

HMD 812 includes a front body 814 and a frame 816 (e.g., a strap or band) shaped to fit around a user’s head. In some embodiments, front body 814 and/or frame 816 include one or more electronic elements for facilitating presentation of and/or interactions with an AR and/or VR system (e.g., displays, IMUs, tracking emitter or detectors). In some embodiments, HMD 812 includes output audio transducers (e.g., an audio transducer 818), as shown in FIG. 8B. In some embodiments, one or more components, such as the output audio transducer(s) 818 and frame 816, can be configured to attach and detach (e.g., are detachably attachable) to HMD 812 (e.g., a portion or all of frame 816, and/or audio transducer 818), as shown in FIG. 8B. In some embodiments, coupling a detachable component to HMD 812 causes the detachable component to come into electronic communication with HMD 812.

FIGS. 8A and 8B also show that VR system 810 includes one or more cameras, such as left camera 839A and right camera 839B, which can be analogous to left and right cameras 739A and 739B on frame 704 of eyewear device 702. In some embodiments, VR system 810 includes one or more additional cameras (e.g., cameras 839C and 839D), which can be configured to augment image data obtained by left and right cameras 839A and 839B by providing more information. For example, camera 839C can be used to supply color information that is not discerned by cameras 839A and 839B. In some embodiments, one or more of cameras 839A to 839D can include an optional IR cut filter configured to remove IR light from being received at the respective camera sensors.

FIG. 9 illustrates a computing system 920 and an optional housing 990, each of which show components that can be included in AR system 700 and/or VR system 810. In some embodiments, more or fewer components can be included in optional housing 990 depending on practical restraints of the respective AR system being described.

In some embodiments, computing system 920 can include one or more peripherals interfaces 922A and/or optional housing 990 can include one or more peripherals interfaces 922B. Each of computing system 920 and optional housing 990 can also include one or more power systems 942A and 942B, one or more controllers 946 (including one or more haptic controllers 947), one or more processors 948A and 948B (as defined above, including any of the examples provided), and memory 950A and 950B, which can all be in electronic communication with each other. For example, the one or more processors 948A and 948B can be configured to execute instructions stored in memory 950A and 950B, which can cause a controller of one or more of controllers 946 to cause operations to be performed at one or more peripheral devices connected to peripherals interface 922A and/or 922B. In some embodiments, each operation described can be powered by electrical power provided by power system 942A and/or 942B.

In some embodiments, peripherals interface 922A can include one or more devices configured to be part of computing system 920, some of which have been defined above and/or described with respect to wrist-wearable devices. For example, peripherals interface 922A can include one or more sensors 923A. Some example sensors 923A include one or more coupling sensors 924, one or more acoustic sensors 925, one or more imaging sensors 926, one or more EMG sensors 927, one or more capacitive sensors 928, one or more IMU sensors 929, and/or any other types of sensors explained above or described with respect to any other embodiments discussed herein.

In some embodiments, peripherals interfaces 922A and 922B can include one or more additional peripheral devices, including one or more NFC devices 930, one or more GPS devices 931, one or more LTE devices 932, one or more Wi-Fi and/or Bluetooth devices 933, one or more buttons 934 (e.g., including buttons that are slidable or otherwise adjustable), one or more displays 935A and 935B, one or more speakers 936A and 936B, one or more microphones 937, one or more cameras 938A and 938B (e.g., including the left camera 939A and/or a right camera 939B), one or more haptic devices 940, and/or any other types of peripheral devices defined above or described with respect to any other embodiments discussed herein.

AR systems can include a variety of types of visual feedback mechanisms (e.g., presentation devices). For example, display devices in AR system 700 and/or VR system 810 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user’s vision. Some embodiments of AR systems also include optical subsystems having one or more lenses (e.g., conventional concave or convex lenses, Fresnel lenses, or adjustable liquid lenses) through which a user can view a display screen.

For example, respective displays 935A and 935B can be coupled to each of the lenses 706-1 and 706-2 of AR system 700. Displays 935A and 935B may be coupled to each of lenses 706-1 and 706-2, which can act together or independently to present an image or series of images to a user. In some embodiments, AR system 700 includes a single display 935A or 935B (e.g., a near-eye display) or more than two displays 935A and 935B. In some embodiments, a first set of one or more displays 935A and 935B can be used to present an augmented-reality environment, and a second set of one or more display devices 935A and 935B can be used to present a virtual-reality environment. In some embodiments, one or more waveguides are used in conjunction with presenting artificial-reality content to the user of AR system 700 (e.g., as a means of delivering light from one or more displays 935A and 935B to the user’s eyes). In some embodiments, one or more waveguides are fully or partially integrated into the eyewear device 702. Additionally, or alternatively to display screens, some artificial-reality systems include one or more projection systems. For example, display devices in AR system 700 and/or VR system 810 can include micro-LED projectors that project light (e.g., using a waveguide) into display devices, such as clear combiner lenses that allow ambient light to pass through. The display devices can refract the projected light toward a user’s pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 935A and 935B.

Computing system 920 and/or optional housing 990 of AR system 700 or VR system 810 can include some or all of the components of a power system 942A and 942B. Power systems 942A and 942B can include one or more charger inputs 943, one or more PMICs 944, and/or one or more batteries 945A and 944B.

Memory 950A and 950B may include instructions and data, some or all of which may be stored as non-transitory computer-readable storage media within the memories 950A and 950B. For example, memory 950A and 950B can include one or more operating systems 951, one or more applications 952, one or more communication interface applications 953A and 953B, one or more graphics applications 954A and 954B, one or more AR processing applications 955A and 955B, and/or any other types of data defined above or described with respect to any other embodiments discussed herein.

Memory 950A and 950B also include data 960A and 960B, which can be used in conjunction with one or more of the applications discussed above. Data 960A and 960B can include profile data 961, sensor data 962A and 962B, media content data 963A, AR application data 964A and 964B, and/or any other types of data defined above or described with respect to any other embodiments discussed herein.

In some embodiments, controller 946 of eyewear device 702 may process information generated by sensors 923A and/or 923B on eyewear device 702 and/or another electronic device within AR system 700. For example, controller 946 can process information from acoustic sensors 725-1 and 725-2. For each detected sound, controller 946 can perform a direction of arrival (DOA) estimation to estimate a direction from which the detected sound arrived at eyewear device 702 of R system 700. As one or more of acoustic sensors 925 (e.g., the acoustic sensors 725-1, 725-2) detects sounds, controller 946 can populate an audio data set with the information (e.g., represented in FIG. 9 as sensor data 962A and 962B).

In some embodiments, a physical electronic connector can convey information between eyewear device 702 and another electronic device and/or between one or more processors 748, 948A, 948B of AR system 700 or VR system 810 and controller 946. The information can be in the form of optical data, electrical data, wireless data, or any other transmittable data form. Moving the processing of information generated by eyewear device 702 to an intermediary processing device can reduce weight and heat in the eyewear device, making it more comfortable and safer for a user. In some embodiments, an optional wearable accessory device (e.g., an electronic neckband) is coupled to eyewear device 702 via one or more connectors. The connectors can be wired or wireless connectors and can include electrical and/or non-electrical (e.g., structural) components. In some embodiments, eyewear device 702 and the wearable accessory device can operate independently without any wired or wireless connection between them.

In some situations, pairing external devices, such as an intermediary processing device with eyewear device 702 (e.g., as part of AR system 700) enables eyewear device 702 to achieve a similar form factor of a pair of glasses while still providing sufficient battery and computation power for expanded capabilities. Some, or all, of the battery power, computational resources, and/or additional features of AR system 700 can be provided by a paired device or shared between a paired device and eyewear device 702, thus reducing the weight, heat profile, and form factor of eyewear device 702 overall while allowing eyewear device 702 to retain its desired functionality. For example, the wearable accessory device can allow components that would otherwise be included on eyewear device 702 to be included in the wearable accessory device and/or intermediary processing device, thereby shifting a weight load from the user’s head and neck to one or more other portions of the user’s body. In some embodiments, the intermediary processing device has a larger surface area over which to diffuse and disperse heat to the ambient environment. Thus, the intermediary processing device can allow for greater battery and computation capacity than might otherwise have been possible on eyewear device 702 standing alone. Because weight carried in the wearable accessory device can be less invasive to a user than weight carried in the eyewear device 702, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user’s day-to-day activities.

AR systems can include various types of computer vision components and subsystems. For example, AR system 700 and/or VR system 810 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use’s real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 8A and 8B show VR system 810 having cameras 839A to 839D, which can be used to provide depth information for creating a voxel field and a two-dimensional mesh to provide object information to the user to avoid collisions.

In some embodiments, AR system 700 and/or VR system 810 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 700 and/or VR system 810, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user’s field of view (e.g., a portion of the AR environment co-located with a physical object in the user’s real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

FIG. 10 is an illustration of an example system 1000 that incorporates an eye-tracking subsystem capable of tracking a user’s eye(s). As depicted in FIG. 10, system 1000 may include a light source 1002, an optical subsystem 1004, an eye-tracking subsystem 1006, and/or a control subsystem 1008. In some examples, light source 1002 may generate light for an image (e.g., to be presented to an eye 1001 of the viewer). Light source 1002 may represent any of a variety of suitable devices. For example, light source 1002 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray’s actual divergence.

In some embodiments, optical subsystem 1004 may receive the light generated by light source 1002 and generate, based on the received light, converging light 1020 that includes the image. In some examples, optical subsystem 1004 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1020. Further, various mechanical couplings may serve to maintain the relative spacing and/or the orientation of the optical components in any suitable combination.

In one embodiment, eye-tracking subsystem 1006 may generate tracking information indicating a gaze angle of an eye 1001 of the viewer. In this embodiment, control subsystem 1008 may control aspects of optical subsystem 1004 (e.g., the angle of incidence of converging light 1020) based at least in part on this tracking information. Additionally, in some examples, control subsystem 1008 may store and utilize historical tracking information (e.g., a history of the tracking information over a given duration, such as the previous second or fraction thereof) to anticipate the gaze angle of eye 1001 (e.g., an angle between the visual axis and the anatomical axis of eye 1001). In some embodiments, eye-tracking subsystem 1006 may detect radiation emanating from some portion of eye 1001 (e.g., the cornea, the iris, the pupil, or the like) to determine the current gaze angle of eye 1001. In other examples, eye-tracking subsystem 1006 may employ a wavefront sensor to track the current location of the pupil.

Any number of techniques can be used to track eye 1001. Some techniques may involve illuminating eye 1001 with infrared light and measuring reflections with at least one optical sensor that is tuned to be sensitive to the infrared light. Information about how the infrared light is reflected from eye 1001 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1006 may be digitized (i.e., converted to an electronic signal). Further, the sensor may transmit a digital representation of this electronic signal to one or more processors (for example, processors associated with a device including eye-tracking subsystem 1006). Eye-tracking subsystem 1006 may include any of a variety of sensors in a variety of different configurations. For example, eye-tracking subsystem 1006 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1006 to track the movement of eye 1001. In another example, these processors may track the movements of eye 1001 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1006 may be programmed to use an output of the sensor(s) to track movement of eye 1001. In some embodiments, eye-tracking subsystem 1006 may analyze the digital representation generated by the sensors to extract eye rotation information from changes in reflections. In one embodiment, eye-tracking subsystem 1006 may use corneal reflections or glints (also known as Purkinje images) and/or the center of the eye’s pupil 1022 as features to track over time.

In some embodiments, eye-tracking subsystem 1006 may use the center of the eye’s pupil 1022 and infrared or near-infrared, non-collimated light to create corneal reflections. In these embodiments, eye-tracking subsystem 1006 may use the vector between the center of the eye’s pupil 1022 and the corneal reflections to compute the gaze direction of eye 1001. In some embodiments, the disclosed systems may perform a calibration procedure for an individual (using, e.g., supervised or unsupervised techniques) before tracking the user’s eyes. For example, the calibration procedure may include directing users to look at one or more points displayed on a display while the eye-tracking system records the values that correspond to each gaze position associated with each point.

In some embodiments, eye-tracking subsystem 1006 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1001 may act as a retroreflector as the light reflects off the retina, thereby creating a bright pupil effect similar to a red-eye effect in photography. If the illumination source is offset from the optical path, then the eye’s pupil 1022 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1008 may control light source 1002 and/or optical subsystem 1004 to reduce optical aberrations (e.g., chromatic aberrations and/or monochromatic aberrations) of the image that may be caused by or influenced by eye 1001. In some examples, as mentioned above, control subsystem 1008 may use the tracking information from eye-tracking subsystem 1006 to perform such control. For example, in controlling light source 1002, control subsystem 1008 may alter the light generated by light source 1002 (e.g., by way of image rendering) to modify (e.g., pre-distort) the image so that the aberration of the image caused by eye 1001 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user’s eye may necessitate modification of a corresponding eye-tracking algorithm. For example, eye-tracking algorithms may need to be modified based at least in part on the differing color contrast between a brown eye and, for example, a blue eye.

FIG. 11 is a more detailed illustration of various aspects of the eye-tracking subsystem illustrated in FIG. 10. As shown in this figure, an eye-tracking subsystem 1100 may include at least one source 1104 and at least one sensor 1106. Source 1104 generally represents any type or form of element capable of emitting radiation. In one example, source 1104 may generate visible, infrared, and/or near-infrared radiation. In some examples, source 1104 may radiate non-collimated infrared and/or near-infrared portions of the electromagnetic spectrum towards an eye 1102 of a user. Source 1104 may utilize a variety of sampling rates and speeds. For example, the disclosed systems may use sources with higher sampling rates in order to capture fixational eye movements of a user’s eye 1102 and/or to correctly measure saccade dynamics of the user’s eye 1102. As noted above, any type or form of eye-tracking technique may be used to track the user’s eye 1102, including optical-based eye-tracking techniques, ultrasound-based eye-tracking techniques, etc.

Sensor 1106 generally represents any type or form of element capable of detecting radiation, such as radiation reflected off the user’s eye 1102. Examples of sensor 1106 include, without limitation, a charge coupled device (CCD), a photodiode array, a complementary metal-oxide-semiconductor (CMOS) based sensor device, and/or the like. In one example, sensor 1106 may represent a sensor having predetermined parameters, including, but not limited to, a dynamic resolution range, linearity, and/or other characteristic selected and/or designed specifically for eye tracking.

As detailed above, eye-tracking subsystem 1100 may generate one or more glints. As detailed above, a glint 1103 may represent reflections of radiation (e.g., infrared radiation from an infrared source, such as source 1104) from the structure of the user’s eye. In various embodiments, glint 1103 and/or the user’s pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 11 shows an example image 1105 captured by an eye-tracking subsystem, such as eye-tracking subsystem 1100. In this example, image 1105 may include both the user’s pupil 1108 and a glint 1110 near the same. In some examples, pupil 1108 and/or glint 1110 may be identified using an artificial-intelligence-based algorithm, such as a computer-vision-based algorithm. In one embodiment, image 1105 may represent a single frame in a series of frames that may be analyzed continuously in order to track the eye 1102 of the user. Further, pupil 1108 and/or glint 1110 may be tracked over a period of time to determine a user’s gaze.

In one example, eye-tracking subsystem 1100 may be configured to identify and measure the inter-pupillary distance (IPD) of a user. In some embodiments, eye-tracking subsystem 1100 may measure and/or calculate the IPD of the user while the user is wearing the artificial reality system. In these embodiments, eye-tracking subsystem 1100 may detect the positions of a user’s eyes and may use this information to calculate the user’s IPD.

As noted, the eye-tracking systems or subsystems disclosed herein may track a user’s eye position and/or eye movement in a variety of ways. In one example, one or more light sources and/or optical sensors may capture an image of the user’s eyes. The eye-tracking subsystem may then use the captured information to determine the user’s inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user’s pupil and a display may change as the user’s eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user’s eyes and applying a distortion correction corresponding to the 3D position of each of the user’s eyes at a given point in time. Thus, knowing the 3D position of each of a user’s eyes may allow for the mitigation of distortion caused by changes in the distance between the pupil of the eye and the display by applying a distortion correction for each 3D eye position. Furthermore, as noted above, knowing the position of each of the user’s eyes may also enable the eye-tracking subsystem to make automated adjustments for a user’s IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user’s gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user’s eyes are verged is where the user is looking and is also typically the location where the user’s eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user’s eyes are directed. Thus, the vergence distance may allow for the determination of a location where the user’s eyes should be focused and a depth from the user’s eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user’s vergence depth. When the user is focused on something at a distance, the user’s pupils may be slightly farther apart than when the user is focused on something close. The eye-tracking subsystem may obtain information about the user’s vergence or focus depth and may adjust the display subsystem to be closer together when the user’s eyes focus or verge on something close and to be farther apart when the user’s eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user’s eye movement, such that if a user is looking up, the computer-generated images may be moved upward on the screen. Similarly, if the user is looking to the side or down, the computer-generated images may be moved to the side or downward on the screen. If the user’s eyes are closed, the computer-generated images may be paused or removed from the display and resumed once the user’s eyes are back open.

The above-described eye-tracking subsystems can be incorporated into one or more of the various artificial reality systems described herein in a variety of ways. For example, one or more of the various components of system 1000 and/or eye-tracking subsystem 1100 may be incorporated into any of the augmented-reality systems in and/or virtual-reality systems described herein in to enable these systems to perform various eye-tracking tasks (including one or more of the eye-tracking operations described herein).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive control signals to be transformed, transform the control signals, output a result of the transformation to oscillate and/or illuminate a MEMS mirror, use the result of the transformation to illuminate a user’s eye, and store the result of the transformation to record and/or detect a gaze direction of the user’s eye. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus, comprising:
a micro-electromechanical systems (MEMS) mirror configured to oscillate at a first resonant frequency about a first axis and at a second resonant frequency about a second axis; and
a laser light source configured to direct light to the MEMS mirror to reflect from the MEMS mirror toward a user’s eye for illumination of the user’s eye,
wherein the MEMS mirror is configured to illuminate the user’s eye in a scanning pattern that can repeat at a rate, and the rate of the scanning pattern is tunable by altering a ratio of the first resonant frequency and the second resonant frequency within a range of 1.1:0..8 to 1.1:0..2.

2. The apparatus of claim 1, wherein the rate is at least 100 times per second.

3. The apparatus of claim 1, wherein the first resonant frequency is more than 18 kHz and the second resonant frequency is more than 36 KHz.

4. The apparatus of claim 1, further comprising a support substrate that supports the MEMS mirror.

5. The apparatus of claim 4, wherein the laser light source is mounted to the support substrate.

6. The apparatus of claim 4, further comprising a light detector mounted to the support substrate.

7. The apparatus of claim 6, further comprising a computing system configured to receive a signal from the light detector and to determine a gaze direction of the user’s eye based on the signal.

8. The apparatus of claim 6, wherein the light detector is configured to detect a two-dimensional image of the user’s eye.

9. The apparatus of claim 4, wherein the support substrate and MEMS mirror has a size of 1.6 mm by 1.6 mm or less.

10. The apparatus of claim 1, further comprising an optical window positioned over the MEMS mirror, the optical window oriented at an angle to the MEMS mirror.

11. The apparatus of claim 10, wherein the optical window comprises a quarter wave plate that alters a polarization state of light passing through the optical window.

12. The apparatus of claim 1, further comprising:
a beam shaping optic configured to focus the light from the laser light source onto at least one of a polarization beam splitter or a reflector.

13. The apparatus of claim 12, wherein the beam shaping optic corresponds to at least one of:
a lens;
a meta lens; or
a diffractive optic.

14. The apparatus of claim 1, further comprising:
a polarization beam splitter configured redirect light from the laser light source to the MEMS mirror and from the MEMS mirror to a light detector.

15. The apparatus of claim 14, further comprising:
a beam shaping optic configured to focus light from the polarization beam splitter onto the light detector.

16. A system comprising:
an eye tracking eye piece having an aperture;
a plurality of detection photodiodes arranged about the aperture; and
a sensing micro-electromechanical systems (MEMS) scanner module integrated into the eye tracking eye piece, wherein the MEMS scanner module includes:
a MEMS mirror configured to oscillate at a first resonant frequency about a first axis and at a second resonant frequency about a second axis; and
a laser light source configured to direct light to the MEMS mirror to reflect from the MEMS mirror toward a user’s eye for illumination of the user’s eye,
wherein the MEMS mirror is configured to illuminate the user’s eye in a scanning pattern that can repeat at a rate, and the rate of the scanning pattern is tunable by altering a ratio of the first resonant frequency and the second resonant frequency within a range of 1.1:0..8 to 1.1:0.2.

17. The system of claim 16, wherein the sensing MEMS scanner module is integrated at a temporal position of the eye tracking eye piece, the system further comprising:
an additional sensing MEMS scanner module integrated at a nasal position of the eye tracking eye piece.

18. A method comprising:
oscillating a micro-electromechanical systems (MEMS) mirror at a first resonant frequency about a first axis and at a second resonant frequency about a second axis;
directing light from a laser light source to the MEMS mirror to reflect from the MEMS mirror toward a user’s eye for illumination of the user’s eye, wherein the MEMS mirror is configured to illuminate the user’s eye in a scanning pattern that repeats at a rate; and
tuning the rate of the scanning pattern by altering a ratio of the first resonant frequency and the second resonant frequency within a range of 1.1:0..8 to 1.1:0.2.

19. The method of claim 18, further comprising:
receiving a signal from a light detector configured to detect light reflected from the user’s eye.

20. The method of claim 19, further comprising:
determining a gaze direction of the user’s eye based on the signal.
